(19) United States
(12) Patent Application Publication
(10) Pub. No.: US 2023/0219546 A1
(43) Pub. Date: Jul. 13, 2023

(54) METHOD FOR OPERATING A BRAKE SYSTEM OF A VEHICLE, CONTROL DEVICE FOR A BRAKE SYSTEM, AND BRAKE SYSTEM

(71) Applicant: Robert Bosch GmbH, Stuttgart (DE)

(72) Inventors: Andreas Haun, Grosswallstadt (DE); Dominic Zipprich, Winzerhausen (DE)

(21) Appl. No.: 18/002,152

(22) PCT Filed: Sep. 22, 2021
(86) PCT No.: PCT/EP2021/076009

§ 371 Date: Dec. 16, 2022

(30) Foreign Application Priority Data
Nov. 18, 2020 (DE) 10 2020 214 482.6

(51) Int. Cl. B60T 8/32; B60T 7/22

(52) U.S. Cl. CPC B60T 8/3275; B60T 7/22; B60T 2201/03; B60T 2220/04

(57) ABSTRACT

A method for operating a brake system of a vehicle. The brake system having: a first and a second actuator for generating a hydraulic pressure in the brake system; a first control device designed to control the first actuator; and a second control device designed to control the second actuator. In the method, the brake system is monitored for emergency braking, wherein the first actuator is controlled by the first control device to generate a first hydraulic pressure for achieving a pre-specified emergency deceleration of the vehicle if emergency braking is detected. The second control device is controlled by the first control device to control the second actuator to generate a second hydraulic pressure when the deceleration that can be or is achieved by means of the first actuator is less than the pre-specified emergency deceleration.

### FIELD

The present invention relates to a method for operating a brake system of a vehicle, having a first and a second actuator for generating a hydraulic pressure in the brake system, having a first control device which is configured to control the first actuator, and having a second control device which is configured to control the second actuator, wherein the brake system is monitored for emergency braking, wherein the first actuator is controlled by the first control device to generate a first hydraulic pressure for achieving a prespecified emergency deceleration of the vehicle when emergency braking is detected.

The present invention also relates to first and a second control device for a brake system and a brake system of a vehicle.

### BACKGROUND INFORMATION

Methods, control devices and brake systems of the aforementioned type are described in the related art. It is in particular a conventional procedure to assist a driver of a vehicle on the basis of detected emergency braking to achieve full deceleration of the vehicle. When emergency braking is detected by an assistance system of the vehicle, in particular a hydraulic brake assist system, full deceleration of the vehicle until the vehicle comes to a standstill is initiated. Activation of the hydraulic brake assist system is intended to achieve a prespecified emergency deceleration, in particular a maximum possible deceleration, of the vehicle as quickly as possible. For this purpose, actuators of the brake system of the vehicle, in particular electromechanical brake boosters or hydraulic pumps of an electronic stability program, are controlled by control devices to generate a hydraulic pressure in the brake system such that the maximum possible deceleration of the vehicle is achieved. The brake pressures on the wheel brakes of the vehicle are therefore in particular set such that the brake pressures are increased up to the control range of an anti-lock braking system, i.e., up to the locking pressure or the locking limit of the individual wheels.

### SUMMARY

In the method according to the present invention, the second control device is controlled by the first control device to control the second actuator to generate a second hydraulic pressure when the deceleration that can be or is achieved by means of the first actuator is less than the pre-specified emergency deceleration. Such a control of the second control device by the first control device ensures that the prespecified emergency deceleration of the vehicle is achieved at all times with the aid of the second actuator. The second control device thus receives a request to support the first control device or to initiate emergency braking. The second control device moreover does not have to monitor the brake system for emergency braking; this task can instead be carried out by the first control device. The second control device is preferably part of an electronic stability program or anti-lock braking system of the vehicle. The first control device preferably controls a part of the in particular electromechanical brake system that can be controlled independently thereof. The first control device preferably obtains information about the achieved deceleration of the vehicle and/or a control state of the anti-lock braking system, in particular a brake slip, from sensors assigned in particular to the electronic stability program. With the aid of this information, it is advantageously achieved that the hydraulic pressure is initially limited to a maximum hydraulic pressure that can be achieved by the first actuator and, only when this hydraulic pressure is insufficient to achieve the prespecified emergency deceleration, is the second control device activated to control the second actuator. The prespecified emergency deceleration is preferably a minimum deceleration specified or required by law, in particular by an ECE regulation.

According to a preferred further development of the present invention, it is provided that vehicle data of the vehicle are monitored to detect emergency braking. Monitoring vehicle data of the vehicle to detect emergency braking advantageously ensures that the presence of a need for emergency braking is reliably identified. Preferably, vehicle data of the vehicle that are already available are monitored, so that no additional vehicle data or input signals have to be assigned to the brake system.

According to a preferred further development of the present invention, it is provided that the vehicle data include an actuating path and a speed of actuation of a brake pedal by a driver, and that emergency braking is initiated when the actuating path and the speed both exceed a prespecified limit value. Such monitoring of the actuating path and the speed of actuation of the brake pedal makes it possible to determine with the aid of a simple evaluation logic whether emergency braking has to be initiated. This monitoring can also be used advantageously in brake systems in which the brake pedal or the actuation of the brake pedal is completely mechanically decoupled from the brake circuit, i.e., the driver brakes in a pedal force simulator. The simulator pressure and the input rod travel which result from the actuation of the brake pedal are preferably used to interpret a braking request of the driver and are used to identify emergency braking.

According to a preferred further development of the present invention, it is provided that the vehicle data include sensor data from sensors of the vehicle that acquire information about the surroundings of the vehicle, and that emergency braking is initiated when a dangerous driving situation is identified during the evaluation of the sensor data. A dangerous driving situation exists in particular when the distance to a preceding vehicle is too small or there are obstacles in the road, so that the vehicle has to be slowed to avoid an accident. Monitoring and evaluating sensor data to detect the dangerous driving situation from sensors that acquire information about the surroundings of the vehicle advantageously ensures that emergency braking can be initiated early enough, even if the driver has not yet requested braking, in particular by actuating the brake pedal, or the driver has not detected the dangerous driving situation or has not yet identified it as such. The method can thus advantageously also be implemented with autonomous braking, i.e., without driver intervention.

According to a preferred further development of the present invention, it is provided that an actual deceleration of the vehicle is measured and that the second actuator is controlled only when the actual deceleration is less than the prespecified emergency deceleration. Such a control of the second actuator only when the measured actual deceleration is insufficient, advantageously ensures that the second actuator is not controlled unnecessarily or the hydraulic pressure is not increased unnecessarily. The system preferably monitors whether the goal of full deceleration has already been achieved, wherein the second actuator is then also not controlled by the second control device. Likewise, measuring the actual deceleration of the vehicle advantageously makes it possible to reliably identify whether the brake system is in a fault condition, caused in particular by brake fade, in which the deceleration of the vehicle to be expected by specified control of the first actuator by the first control device cannot be achieved.

According to a preferred further development of the present invention, it is provided that an actual hydraulic pressure is measured in the brake system and that the second actuator is activated only when the actual hydraulic pressure is less than a target hydraulic pressure which is prespecified as a function of the prespecified emergency deceleration. Such a control of the second actuator, only when the measured actual hydraulic pressure is insufficient, advantageously ensures that the second actuator is not controlled unnecessarily or the hydraulic pressure is not increased unnecessarily.

According to a preferred further development of the present invention, it is provided that the second actuator is controlled to generate a maximum possible hydraulic pressure when no actual deceleration and/or no actual hydraulic pressure can be measured. Such a control of the second actuator to generate the maximum possible hydraulic pressure creates an advantageous fallback level in the event that no measurement data for the actual deceleration or the actual hydraulic pressure are available. This increases the fail-safety of the brake system at least to the extent that, in the event of a failure of the Substitute Specification sensor system, the second control device and the second actuator continue to ensure sufficient deceleration during emergency braking.

With respect to the first and second control device according to an example embodiment of the present invention for a brake system, the control devices are specifically designed to carry out the method according to the present invention. This results in the aforementioned advantages.

A brake system according to an example embodiment of the present invention comprises a first and a second actuator for generating a hydraulic pressure in the brake system and is characterized by the control devices according to the present invention. This, too, results in the aforementioned advantages.

Further preferred features and combinations of features result from the disclosure herein. The present invention will be explained in more detail in the following with reference to the figures.

### BRIEF DESCRIPTION OF THE DRAWINGS

FIG. 1 shows a brake system in a schematic illustration, according to an example embodiment of the present invention.

FIG. 2 shows a method for operating the brake system, according to an example embodiment of the present invention.

FIG. 3 shows characteristic curves of pressure progressions in the brake system, according to an example embodiment of the present invention.

FIG. 4 shows further characteristic curves of pressure progressions in the brake system, according to an example embodiment of the present invention.

### DETAILED DESCRIPTION OF EXAMPLE EMBODIMENTS

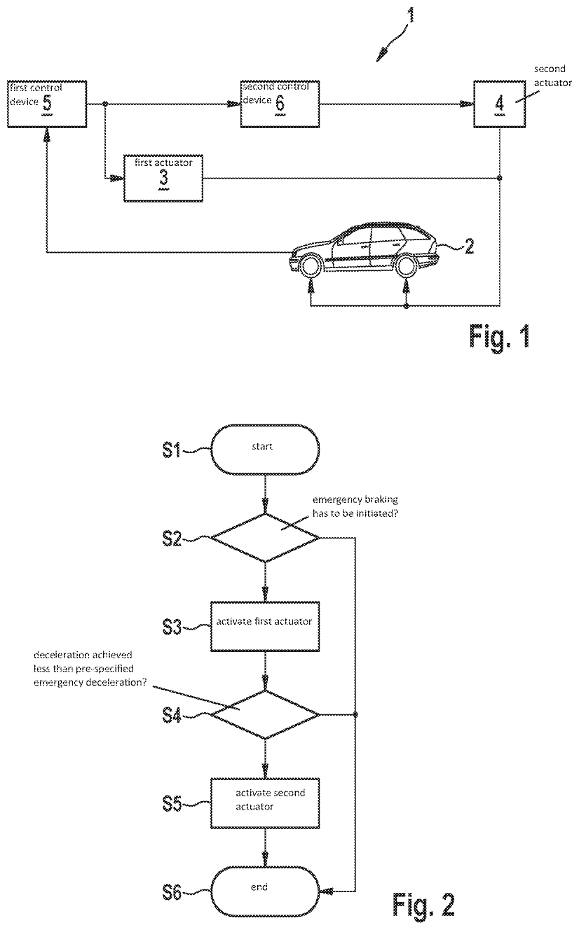

FIG. 1 shows components of a brake system 1 of a vehicle 2 in a schematic illustration. The brake system 1 comprises a first actuator 3 and a second actuator 4. The first actuator 3 and the second actuator 4 are both configured to generate a hydraulic pressure in the brake system 1, so that a brake pressure can be applied to wheel braking devices of the vehicle 2, which are not shown in greater detail. The brake system 1 further comprises a first control device 5 and a second control device 6. The first control device 5 has a communication link with the first actuator 3 and is configured to activate the first actuator 3. The first control device 5 furthermore has a communication link with the second control device 6 and is configured to activate the second control device 6. The first control device 5 also has a communication link with the vehicle 2 such that the brake system 1 can be monitored by the first control device 5 for emergency braking, in particular on the basis of vehicle data of the vehicle 2.

One advantageous method for operating the brake system 1 of the vehicle 2 is described in the following with reference to FIG. 2. For this purpose, FIG. 2 shows the method using a flow chart. The method in particular ensures that the vehicle 2 is braked safely and quickly to a standstill with a prespecified emergency deceleration, or undergoes full deceleration, when emergency braking is identified.

In a Step S1, the method starts with the monitoring of the brake system for emergency braking. Preferably, vehicle data of the vehicle 2 are monitored to detect emergency braking. The vehicle data preferably include an actuating path and a speed of actuation of a brake pedal by a driver and/or sensor data from sensors of the vehicle 2 that acquire information about the surroundings of the vehicle 2.

In a Step S2, the vehicle data is evaluated and checked to determine whether emergency braking has to be initiated. Emergency braking is preferably initiated when the actuating path and speed of actuation of the brake pedal by the driver both exceed a prespecified limit value. Emergency braking is furthermore preferably initiated when a dangerous driving situation is identified during the evaluation of the sensor data from the sensors of the vehicle 2 that acquire information about the surroundings of the vehicle 2. If it is now recognized that there is no need to initiate emergency braking because there is in particular no exceedance of the prespecified limit values in the actuation of the brake pedal nor a dangerous driving situation, the method ends in Step S6.

However, if it is recognized that emergency braking has to be initiated, the method continues with a Step S3. In Step S3, the first actuator 3 is activated by the first control device 5 to generate a first hydraulic pressure p₁ to achieve a prespecified emergency deceleration of the vehicle 2. The prespecified emergency deceleration is in particular a minimum deceleration specified by law.

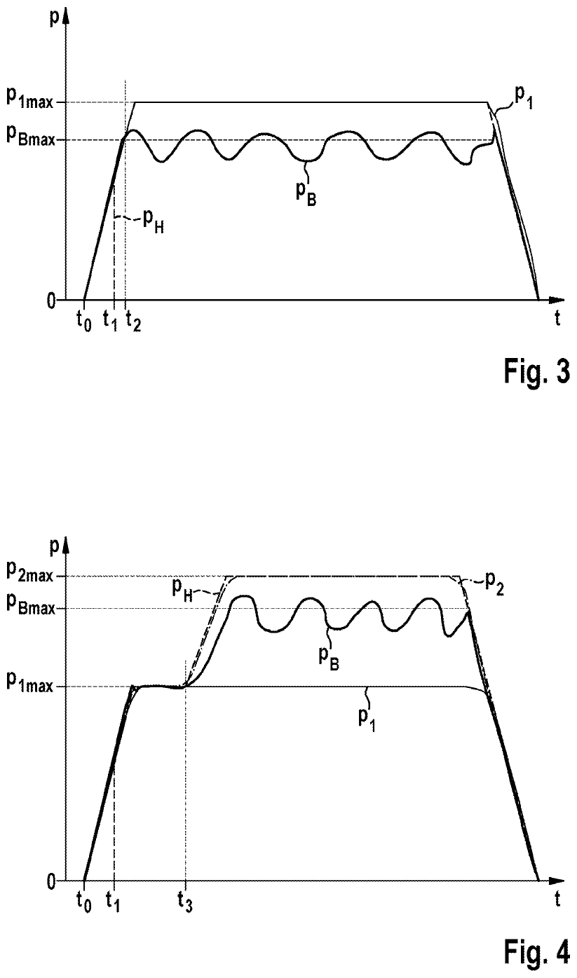

In a Step S4, it is now checked, preferably at a prespecified time after the control of the actuator 3 by the first control device 5, whether the deceleration achieved by the first actuator 3 is less than the prespecified emergency deceleration. An actual deceleration of the vehicle is preferably measured and compared to the prespecified emergency deceleration for this purpose. If the achieved deceleration or the actual deceleration is at least as great as the prespecified emergency deceleration, the method likewise ends in Step S6. This case will be described later with reference to the pressure progressions shown in FIG. 3.

However, if the deceleration achieved by the first actuator 3 is in fact less than the prespecified emergency deceleration, if the achieved deceleration or the actual deceleration cannot be measured, or if the achievable deceleration is already less than the prespecified emergency deceleration, the method is continued with a Step S5. In Step S5, the second control device 6 is activated by the first control device 5 to control the second actuator 4 to generate a second hydraulic pressure p₂ in order to achieve the prespecified emergency deceleration. This case will be described later with reference to the pressure progressions shown in FIG. 4. The method then ends, preferably with the vehicle 2 achieving full deceleration, in Step S6.

FIG. 3 shows characteristic curves of pressure progressions in the brake system 1 when emergency braking is identified. The characteristic curves are shown in a diagram in which the x-axis shows the time t and the y-axis shows the pressure p. The pressure progressions depicted in FIG. 3 make it possible to see a method carried out according to the present invention and according to the description for FIG. 2, in which it was recognized in Step S4 that the achieved deceleration is sufficient and the method ends without the hydraulic pressure having to be increased by the second actuator 4.

At a time t₀, the driver first initiates a braking process in which a brake pressure p_{B} at the wheel braking devices and a first hydraulic pressure p₁ in the brake system increase linearly and are equal in magnitude. At a time t₁, emergency braking is initiated by the first control device 5, so that a progression of a hydraulic pressure p_{H} is now specified in order to achieve a prespecified emergency deceleration. At a time t₂, a maximum brake pressure p_{Bmax} or a locking pressure is achieved at the wheel braking devices.

An anti-lock braking system now intervenes in a controlling manner in the braking process. If the wheels are about to lock, the anti-lock braking system initially reduces the brake pressure p_{B} until the tendency to lock is stopped and then increases it again. From the time t₂, therefore, the brake pressure p_{B} at the wheel braking devices oscillates around the maximum brake pressure p_{Bmax}.

After the time t₂, the first hydraulic pressure p₁ continues to increase until it reaches the maximum first hydraulic pressure p₁ₘₐₓ, which in the present case is as high as the prespecified hydraulic pressure p_{H} and higher than the maximum brake pressure p_{Bmax}, so that the prespecified emergency deceleration is achieved. The generation of a second, higher hydraulic pressure p₂ by the second actuator 4 is therefore not necessary.

FIG. 4 shows further characteristic curves of pressure progressions in the brake system 1 when emergency braking is identified. The characteristic curves are likewise shown in a diagram in which the x-axis shows the time t and the y-axis shows the pressure p. The pressure progressions depicted in FIG. 4 make it possible to see a method carried out according to the present invention and according to the description for Substitute Specification FIG. 2, in which it was recognized in Step S4 that the achieved deceleration is not sufficient and the hydraulic pressure has to be increased by the second actuator 4.

As already described for FIG. 3, at a time t₀, the driver initiates a braking process in which the brake pressure p_{B} at the wheel braking devices and the first hydraulic pressure p₁ in the brake system increase linearly and are equal in magnitude. At the time t₁, emergency braking is again initiated by the first control device 5, so that the progression of a hydraulic pressure p_{H} is now specified in order to achieve the prespecified emergency deceleration. After the time t₁, the first hydraulic pressure p₁ continues to increase to a maximum first hydraulic pressure p₁ₘₐₓ. At a time t₃ it is recognized that the first hydraulic pressure p₁ is less than the maximum brake pressure p_{Bmax} at the wheel braking devices. The second actuator 4 is then activated to increase the hydraulic pressure p_{H} to a maximum second hydraulic pressure p₂ₘₐₓ, which is higher than the maximum brake pressure p_{Bmax}, so that the prespecified emergency deceleration can be achieved.

The brake pressure p_{B} now continues to increase until the maximum brake pressure p_{Bmax} is reached at the wheel braking devices. The anti-lock braking system then again intervenes in a controlling manner in the braking process, as described above, so that the brake pressure p_{B} oscillates around the maximum brake pressure p_{Bmax} in order to achieve the prespecified emergency deceleration.

1-9. (canceled)

10. A method for operating a brake system of a vehicle, the brake system including a first actuator and a second actuator for generating a hydraulic pressure in the brake system, a first control device which is configured to control the first actuator, and a second control device which is configured to control the second actuator, the method comprising the following steps:
monitoring the brake system for emergency braking;
controlling the first actuator, by the first control device, to generate a first hydraulic pressure for achieving a prespecified emergency deceleration of the vehicle when emergency braking is detected; and
controlling the second control device, by the first control device, to control the second actuator to generate a second hydraulic pressure when deceleration that can be or is achieved using the first actuator is less than the pre-specified emergency deceleration.

11. The method according to claim 10, wherein vehicle data of the vehicle are monitored to detect emergency braking.

12. The method according to claim 11, wherein the vehicle data includes an actuating path and a speed of actuation of a brake pedal by a driver, and emergency braking is initiated when the actuating path and the speed both exceed a prespecified limit value.

13. The method according to claim 11, wherein the vehicle data include sensor data from sensors of the vehicle that acquire information about surroundings of the vehicle, and emergency braking is initiated when a dangerous driving situation is identified during the evaluation of the sensor data.

14. The method according to claim 11, wherein an actual deceleration of the vehicle is measured, and that the second actuator is activated only when the actual deceleration is less than the prespecified emergency deceleration.

15. The method according to claim 11, wherein an actual hydraulic pressure in the brake system is measured, and the second actuator is activated only when the actual hydraulic pressure is less than a target hydraulic pressure which is prespecified as a function of the prespecified emergency deceleration.

16. The method according to claim 14, wherein the second actuator is activated to generate a maximum possible hydraulic pressure when no actual deceleration and/or no actual hydraulic pressure can be measured.

17. First and second control devices for a brake system, wherein the brake system includes a first actuator and a second actuator for generating a hydraulic pressure in the brake system, wherein the first control device is configured to control the first actuator, and the second control device is configured to control the second actuator, wherein the first and second control devices are configured to:
monitor the brake system for emergency braking;
control the first actuator, by the first control device, to generate a first hydraulic pressure for achieving a prespecified emergency deceleration of the vehicle when emergency braking is detected; and
control the second control device, by the first control device, to control the second actuator to generate a second hydraulic pressure when deceleration that can be or is achieved using the first actuator is less than the pre-specified emergency deceleration.

18. A brake system of a vehicle, comprising:
a first actuator and a second actuator for generating a hydraulic pressure in the brake system; and
a first control device and a second control device, the first control device being configured to control the first actuator, and the second control device being configured to control the second actuator, wherein the first and second control devices are configured to:
monitor the brake system for emergency braking,
control the first actuator, by the first control device, to generate a first hydraulic pressure for achieving a prespecified emergency deceleration of the vehicle when emergency braking is detected, and
control the second control device, by the first control device, to control the second actuator to generate a second hydraulic pressure when deceleration that can be or is achieved using the first actuator is less than the pre-specified emergency deceleration.
